(19) United States
(12) Patent Application Publication
(10) Pub. No.: US 2026/0274367 A1
(43) Pub. Date: Sep. 17, 2026

(54) COMPONENTS FOR BAMBOO BICYCLE FRAMES AND METHODS FOR CONSTRUCTING BICYCLE FRAMES USING SUCH DEVICES

(71) Applicant: Barefoot Citizens IP PTY LTD, Bulimba (AU)

(72) Inventors: Simon Doble, Bulimba (AU); Alex Chappell, Bulimba (AU); Jason Smith, Bulimba (AU)

(21) Appl. No.: 19/470,725

(22) PCT Filed: Mar. 31, 2023
(86) PCT No.: PCT/IB2023/053277

§ 371 Date: Sep. 29, 2025

(51) Int. Cl. B62K 3/02; B62K 19/14; B62K 19/22; B62K 19/28

(52) U.S. Cl. CPC B62K 3/02; B62K 19/14; B62K 19/22; B62K 19/28

(57) ABSTRACT

The present technology is generally directed to bicycle frame knuckles for use with bamboo frame tubes. In some embodiments, a bicycle frame knuckle can include: a cylindrical housing; a first tube lug extending from the housing and configured to extend into a first end portion of a first bicycle frame tube; and a second tube lug extending from the housing and configured to extend into an end portion of a second bicycle frame tube.

### TECHNICAL FIELD

This patent application generally relates to bicycle frames and, more specifically, to components for constructing bicycle frames from bamboo.

### BACKGROUND

Bamboo is a fast growing tree-like grass. Bamboo is extremely strong; even stronger than steel. The tensile strength of steel is 23,000 PSI, while the tensile strength of bamboo is 28,000 PSI. Bamboo has been used for centuries across Asia and other parts of the world rather than steel due to bamboo's lightness, strength, and environmental benefits. Today, this eco-friendly and sustainable material is being used to reinforce roads and bridges, to construct furniture, rugs, textiles, and even bicycle frames.

### BRIEF DESCRIPTION OF THE DRAWINGS

Many aspects of the present technology can be better understood with reference to the following drawings. The components in the drawings are not necessarily drawn to scale. Instead, emphasis is placed on illustrating clearly the principles of the present technology. Furthermore, components can be shown as transparent in certain views for clarity of illustration only and not to indicate that the component is necessarily transparent. Components may also be shown schematically.

FIG. 1 is a perspective view of a bamboo bicycle frame configured in accordance with embodiments of the disclosed technology.

FIG. 2A is an isometric view of a head tube knuckle configured in accordance with embodiments of the disclosed technology.

FIG. 2B is a side elevational view of the head tube knuckle shown in FIG. 2A.

FIG. 3 is an enlarged partial perspective view illustrating the assembly of the head tube knuckle, top tube, and down tube of the bamboo bicycle frame of FIG. 1.

FIG. 4A is an isometric view of a head tube knuckle configured in accordance with additional embodiments of the disclosed technology.

FIG. 4B is a side elevational view of the head tube knuckle shown in FIG. 4A.

FIG. 5 is a partially exploded isometric view of the head tube knuckle of FIGS. 4A and 4B partially assembled with a down tube and cable housing.

FIG. 6A is an isometric view of a seat tube knuckle configured in accordance with embodiments of the disclosed technology.

FIG. 6B is a side elevational view of the seat tube knuckle shown in FIG. 6A.

FIG. 7A is an isometric view of a bottom bracket knuckle configured in accordance with embodiments of the disclosed technology.

FIG. 7B is a side elevational view of the bottom bracket knuckle shown in FIG. 7A.

FIG. 8A is an isometric view of an inclined head tube knuckle configured in accordance with embodiments of the disclosed technology.

FIG. 8B is a side elevational view of the inclined head tube knuckle shown in FIG. 8A.

FIG. 9A is an isometric view of an inclined head tube adapter configured in accordance with embodiments of the disclosed technology.

FIG. 9B is a side elevational view of the inclined head tube adapter shown in FIG. 9A.

FIG. 10A is an isometric view of a seat tube knuckle configured in accordance with additional embodiments of the disclosed technology.

FIG. 10B is a side elevational view of the seat tube knuckle shown in FIG. 10A.

FIG. 10C is a top plan view of the seat tube knuckle shown in FIGS. 10A and 10B.

FIG. 11A is an isometric view of a bottom bracket knuckle configured in accordance with additional embodiments of the disclosed technology.

FIG. 11B is a side elevational view of the bottom bracket knuckle shown in FIG. 11A.

FIG. 11C is a top plan view of the bottom bracket knuckle shown in FIGS. 11A and 11B.

### DETAILED DESCRIPTION

### Overview

The present technology is generally directed to the construction of bamboo bicycle frames. Conventional bamboo bicycle frames are constructed by simply positioning the various tubes together at a joint and gluing them in place. A strip of material or string is sometimes wrapped around the joint to help support the joint and provide a matrix for the glue. With this type of construction, it can be difficult to keep the various frame tubes properly aligned. Furthermore, the strength of the resulting joint is limited and can fatigue over time. The disclosed bicycle frame knuckle technology is expected to provide increased strength, rigidity, and durability of the frame joints as compared with conventional bamboo bicycle frames, and it is further expected to help maintain frame tube alignment during assembly. For example, a head tube knuckle in accordance with the embodiments of the disclosed technology can include a cylindrical fork tube housing, a top tube lug extending from the fork tube housing, and a down tube lug extending from the fork tube housing. The top tube lug and the down tube lug are each configured to extend into hollow end portions of a bamboo top tube and a bamboo down tube, respectively. The fork tube housing and lugs are securely attached to (e.g., welded) or integrally formed (e.g., cast or molded) with each other to provide a rigid frame joint.

In some aspects, the techniques described herein relate to a bicycle frame, including: a top tube, a down tube, a seat tube, a pair of chain stays, a pair of seat stays, and a pair of dropouts connecting the pair of chain stays with the pair of seat stays; a head tube knuckle, including: a cylindrical fork tube housing; a top tube lug extending from the fork tube housing and into a first end portion of the top tube; and a down tube lug extending from the fork tube housing and into a first end portion of the down tube; a bottom bracket knuckle, including: a cylindrical crank bearing housing; a seat tube lug extending from the crank bearing housing and into a first end portion of the seat tube; a down tube lug extending from the crank bearing housing and into a second end portion of the down tube; and a pair of chain stay lugs each extending from the crank bearing housing and into a corresponding one of the pair of chain stay tubes; and a seat tube knuckle, including: a cylindrical seat post housing extending into a second end portion of the seat tube; a top tube lug extending from the seat post housing and into a second end portion of the top tube; and a pair of seat stay lugs each extending from the seat post housing and into a corresponding one of the pair of seat stay tubes.

The techniques described herein can also relate to a bicycle frame wherein at least one of the top tube, the down tube, the seat tube, the pair of chain stays, and the pair of seat stays is composed of bamboo.

In some embodiments, the techniques described herein relate to a bicycle frame wherein: the head tube knuckle includes at least one channel extending along a length of at least one of the top tube lug and the bottom tube lug, the bottom bracket knuckle includes at least one channel extending along a length of at least one of the down tube lug and the seat tube lug, and the seat tube knuckle includes at least one channel extending along a length of the top tube lug.

The techniques described herein can relate to a bicycle frame, further including a cable housing extending at least partially through the down tube and along a channel extending along a length of the down tube lug.

In some aspects, the techniques described herein relate to a bicycle frame, further including a wire extending through the top tube and at least partially along a channel extending along a length of the top tube lug.

The techniques described herein can further relate to a bicycle frame wherein: the bottom bracket knuckle includes a pair of contoured reinforcement members positioned between the pair of chain stay lugs, wherein each reinforcement member engages an outer surface of a corresponding one of the pair of chain stay tubes, and the seat tube knuckle further includes a pair of contoured reinforcement members positioned between the pair of seat stay lugs and each engaging an outer surface of a corresponding one of the pair of seat stay tubes.

In some embodiments, the techniques described herein relate to a bicycle frame wherein the seat tube knuckle further includes a brake mount extending between the pair of contoured reinforcement members.

The techniques described herein can also relate to a bicycle frame wherein the top tube, the down tube, the seat tube, the pair of chain stays, the pair of seat stays, the head tube knuckle, the bottom bracket knuckle, and the seat tube knuckle are further secured together with epoxy.

In some aspects, the techniques described herein relate to a bicycle frame knuckle, including: a cylindrical housing; a first tube lug extending from the housing and configured to extend into a first end portion of a first bicycle frame tube; and a second tube lug extending from the housing and configured to extend into an end portion of a second bicycle frame tube, wherein at least one of the first tube lug and the second tube lug includes at least one channel formed therein and extending at least partially along its length.

The techniques described herein relate to a bicycle frame knuckle wherein: the housing is a fork tube housing, the first tube lug is a top tube lug, and the second tube lug is a down tube lug.

The techniques described herein can also relate to a bicycle frame knuckle wherein: the housing is a crank bearing housing, the first tube lug is a down tube lug, and the second tube lug is a seat tube lug.

In some embodiments, the techniques described herein relate to a bicycle frame knuckle, further including a pair of chain stay lugs extending from the crank bearing housing.

In some aspects, the techniques described herein relate to a bicycle frame knuckle wherein: the housing is a seat post housing, the first tube lug is a top tube lug, and the second tube lug is a seat tube lug.

The techniques described herein relate to a bicycle frame knuckle, further including a pair of seat stay lugs extending from the seat post housing.

The techniques described herein can relate to a bicycle frame fitting, including: a cylindrical housing; a first tube lug extending from the housing and configured to extend into a first end portion of a first bicycle frame tube; a pair of second tube lugs each extending from the housing and configured to extend into an end portion of a corresponding one of a pair of second bicycle frame tubes; and a pair of contoured reinforcement members positioned between the pair of second tube lugs and positioned to engage an outer surface of a corresponding one of the pair of second bicycle frame tubes.

The techniques described herein can also relate to a bicycle frame fitting wherein: the housing is a crank bearing housing, the first tube lug is a down tube lug, and the pair of second tube lugs are chain stay lugs.

In some aspects, the techniques described herein relate to a bicycle frame fitting, further including a seat tube lug extending from the crank bearing housing.

In some embodiments, the techniques described herein relate to a bicycle frame fitting wherein: the housing is a seat post housing, the first tube lug is a top tube lug, and the pair of second tube lugs are seat stay lugs.

The techniques described herein relate to a bicycle frame fitting, further including a brake mount extending between the pair of contoured reinforcement members.

In some embodiments, the techniques described herein relate to a bicycle frame fitting wherein the frame fitting is composed of metal.

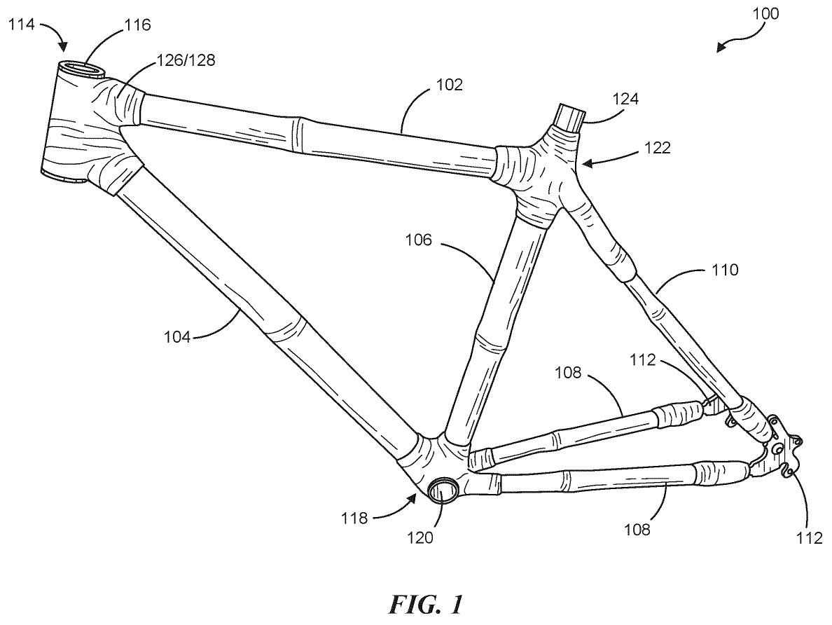

The terminology used in the description presented below is intended to be interpreted in its broadest reasonable manner, even though it is being used in conjunction with a detailed description of certain specific embodiments of the present technology. Certain terms may even be emphasized below; however, any terminology intended to be interpreted in any restricted manner will be overtly and specifically defined as such in this Detailed Description section. Additionally, the present technology can include other embodiments that are within the scope of the examples and claims but are not described in detail with respect to FIGS. 1-11C.

Reference throughout this specification to “one embodiment” or “an embodiment” means that a particular feature, structure, or characteristic described in connection with the embodiment is included in at least one embodiment of the present technology. Thus, the appearances of the phrases “in one embodiment” or “in an embodiment” in various places throughout this specification are not necessarily all referring to the same embodiment. Furthermore, the particular features or characteristics may be combined in any suitable manner in one or more embodiments.

As used herein, the use of relative terminology, such as “about”, “approximately”, “substantially” and the like refer to the stated value plus or minus ten percent. For example, the use of the term “about 100” refers to a range of from 90 to 110, inclusive. In instances in which the context requires otherwise and/or relative terminology is used in reference to something that does not include a numerical value, the terms are given their ordinary meaning to one skilled in the art.

The headings below are provided by way of convenience only and are not to be used to interpret the scope of the claimed technology.

### General Description

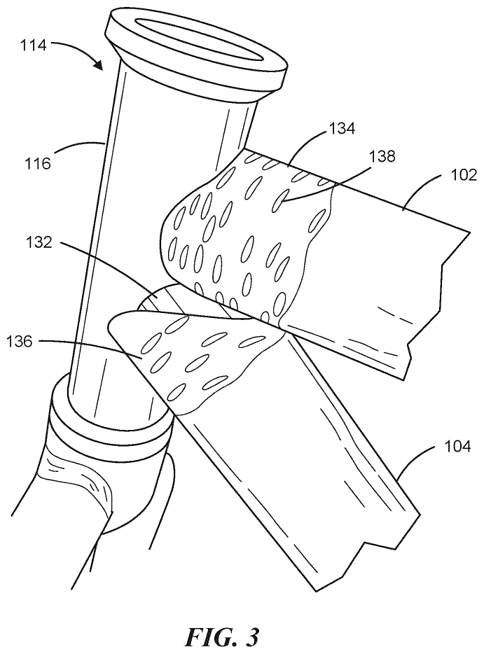

FIG. 1 is a perspective view of a bamboo bicycle frame 100 configured in accordance with embodiments of the disclosed technology. The frame 100 can include a top tube 102, a down tube 104, a seat tube 106, a pair of chain stays 108, a pair of seat stays 110 (only one is visible in FIG. 1), and a pair of dropouts 112 connecting the pair of chain stays 108 with the pair of seat stays 110. The frame 100 also includes a head tube fitting or knuckle 114 that connects the top tube 102 and the down tube 104 to a cylindrical fork tube housing 116 included on the head tube knuckle 114. As used herein the term “knuckle” refers to a fitting including multiple lugs configured to join frame members. As described in greater detail below with respect to FIG. 3, in some embodiments, the frame tubes are further secured to the corresponding fittings or knuckles with binding rope 126 and epoxy 128. The down tube 104, the seat tube 106, and the chain stays 108 are connected together with a bottom bracket fitting or knuckle 118. The bottom bracket knuckle 118 includes a cylindrical crank bearing housing 120 that can be configured to carry a crank set and/or e-bike motor assembly (not shown). The top tube 102, seat tube 106, and seat stays 110 are connected together with a seat tube fitting or knuckle 122. The seat tube knuckle 122 includes a cylindrical seat post housing 124 configured to receive a seat post (not shown). As described in greater detail below, the head tube knuckle 114, the bottom bracket knuckle 118, and the seat tube knuckle 122 each include lugs that extend into a hollow portion of a corresponding frame tube. These lugs provide increased strength, rigidity, and durability of the frame joints and help maintain frame tube alignment during assembly.

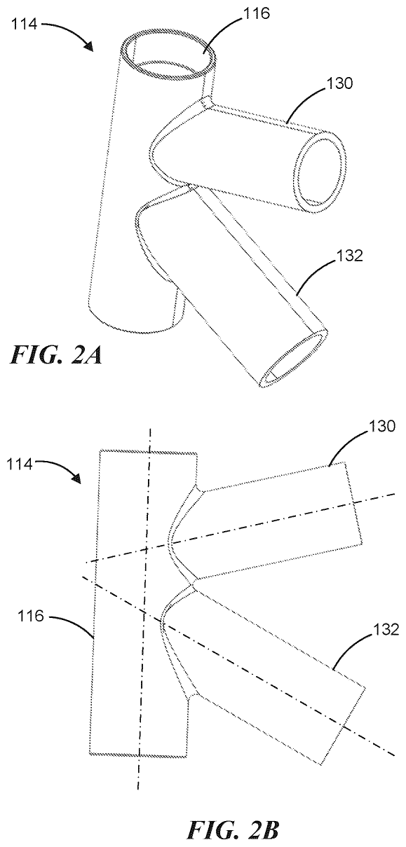

For example, FIGS. 2A and 2B illustrate the head tube knuckle 114 (before assembly) configured in accordance with embodiments of the disclosed technology. For purposes of illustration/clarify, the head tube knuckle 114 is illustrated here before assembly/installation with the top tube 102 (FIG. 1) and down tube 104 (FIG. 1). As best seen in FIG. 2A, the head tube knuckle 114 can include the cylindrical fork tube housing 116, a top tube lug 130 extending from the fork tube housing 116, and a down tube lug 132 extending from the fork tube housing 116. Referring to FIGS. 2A and 2B together, the top tube lug 130 and the down tube lug 132 are each configured to extend into hollow end portions of a bamboo top tube and a bamboo down tube (not shown), respectively. The fork tube housing 116 and lugs 130/132 are securely joined together (e.g., welded) or integrally formed (e.g., cast or molded) with each other to provide a rigid frame joint. In general, the knuckles disclosed herein can be composed of metal (e.g., aluminum or steel) and/or plastic. The knuckles can be formed by welding, casting, forging, machining, and/or additive manufacturing techniques, to name a few examples. As best seen in FIG. 2B, the angles between the fork tube housing 116, the top tube lug 130, and the down tube lug 132 can vary depending on the application; however, the longitudinal axes of these features lie in a common plane. The lugs 130 and 132 can be hollow, solid, or partially hollow.

FIG. 3 is an enlarged partial perspective view illustrating the assembly of the head tube knuckle 114, the top tube 102, and the down tube 104 of the bamboo bicycle frame 100. The top tube 102 and the down tube 104 each include a hollow end portion 134 and 136, respectively. Prior to assembly, the end portions 134 and 136 can be prepared for assembly by conditioning an outer surface of the tubes. For example, the end portions 134 and 136 can be sanded, gouged, carved, or otherwise modified to create features 138 that provide a rough surface to enhance the adhesion of epoxy. The end portions 134 and 136 can also be notched/mitered to provide a tight fit with each other prior to assembly with the knuckle 114. Once the end portions 134 and 136 are prepared, the corresponding lugs 130 (not visible in FIGS. 3) and 132 are inserted into the hollow end portions 134 and 136, respectively. A suitable glue/epoxy can be used to secure the joint between the lugs and end portions along with rope, such as Manila rope or Sisal rope bound and glued around the frame joint, as shown in FIG. 1. An example of a suitable epoxy is Bio-Epoxy commercially available from Change Climate Pty Ltd of Australia. Similar techniques as described above can be used to assemble the remaining frame joints. In other embodiments, however, other suitable epoxies/adhesives and/or ropes/cables may be used. In still further embodiments, epoxies/adhesives and rope(s) may not be used and the corresponding end portions of the tubes may be assembled with the knuckle via only a press-fit arrangement.

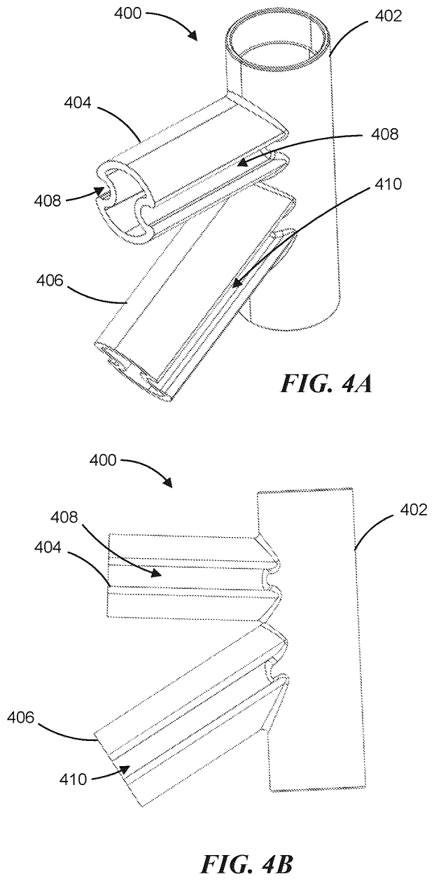

FIGS. 4A and 4B illustrate a head tube fitting or knuckle 400 configured in accordance with additional embodiments of the disclosed technology. The head tube knuckle 400 can include a cylindrical fork tube housing 402, a top tube lug 404 extending from the housing 402 and configured to extend into a first end portion of a bicycle frame top tube, and a down tube lug 406 extending from the housing 402 and configured to extend into an end portion of a bicycle frame down tube. The top tube lug 404 and the down tube lug 406 can each include a pair of channels 408 and 410, respectively, that extend along at least a portion of the length of the lugs. As described in greater detail below, the channels 408 and 410 provide clearance for cable housings and/or wires. The channels 408 and 410 can be positioned on opposite sides of the lugs and/or on the top and bottom of the lugs. In other embodiments, the lugs 404 and 406 may only include a different number of channels (e.g., a single channel, three channels, four channels, etc.).

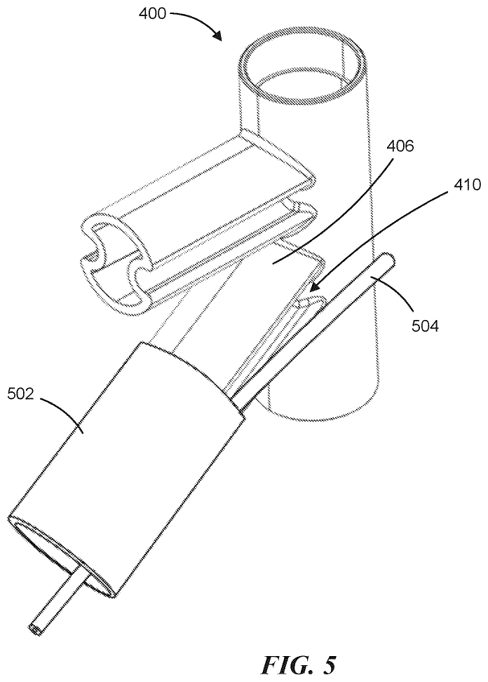

FIG. 5 is a partially exploded isometric view of the head tube knuckle 400 of FIGS. 4A and 4B partially assembled with a down tube 502 and a cable housing 504. The cable housing 504 can extend along the channel 410 between the down tube 502 and the down tube lug 406. Thus, the channel 410 provides clearance to route cables and/or wires through the frame tubes when assembling/operating a bicycle fabricated using the disclosed knuckles.

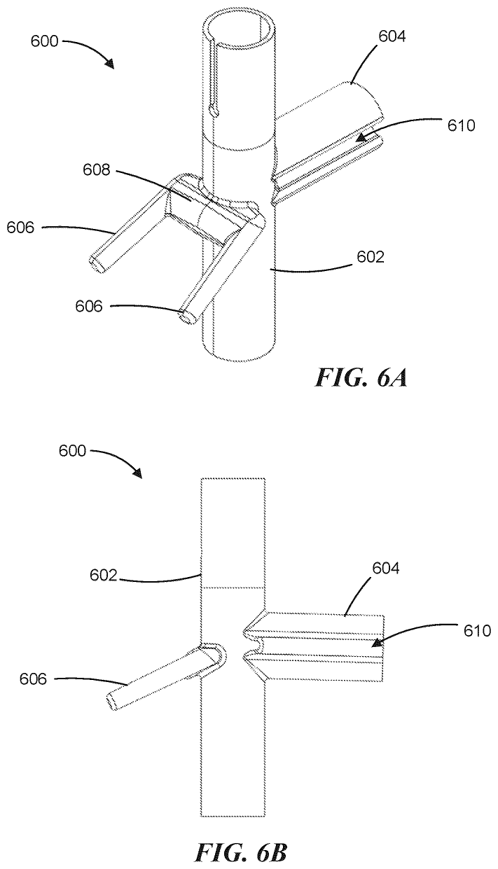

FIGS. 6A and 6B illustrate a seat tube fitting or knuckle 600 configured in accordance with embodiments of the disclosed technology. Referring first to FIG. 6B, the seat tube knuckle 600 can include a cylindrical seat post housing 602 configured to extend into an end portion of a bicycle frame seat tube (e.g., seat tube 106 of FIG. 1). The seat tube knuckle 600 can also include a top tube lug 604 extending from the seat post housing 602 and configured to extend into an end portion of a bicycle frame top tube (e.g., top tube 102 of FIG. 1). Referring to FIGS. 6A and 6B together, a pair of seat stay lugs 606 extend from the seat post housing 602 and are configured to extend into a corresponding one of a pair of seat stay tubes (not shown). In some embodiments, the seat stay lugs 606 can attach to the seat post housing 602 via a cross member 608. The cross member 608 is sized and shaped to allow the seat stay lugs and tubes to be separated a distance sufficient to provide clearance for a wheel (not shown). The top tube lug 604 can include a pair of channels 610 that extend along at least a portion of the length of the top tube lug 604. As described above with respect to FIGS. 4A-5, the channels 610 provide clearance for cable housings and/or wires. The channels 610 can be positioned on opposite sides of the lug 604 and/or on the top and bottom of the lug 604. Furthermore, the seat post housing 602 can also include channels in some embodiments. The channels 610 are an optional feature that may not be included in some embodiments of the seat tube knuckle 600.

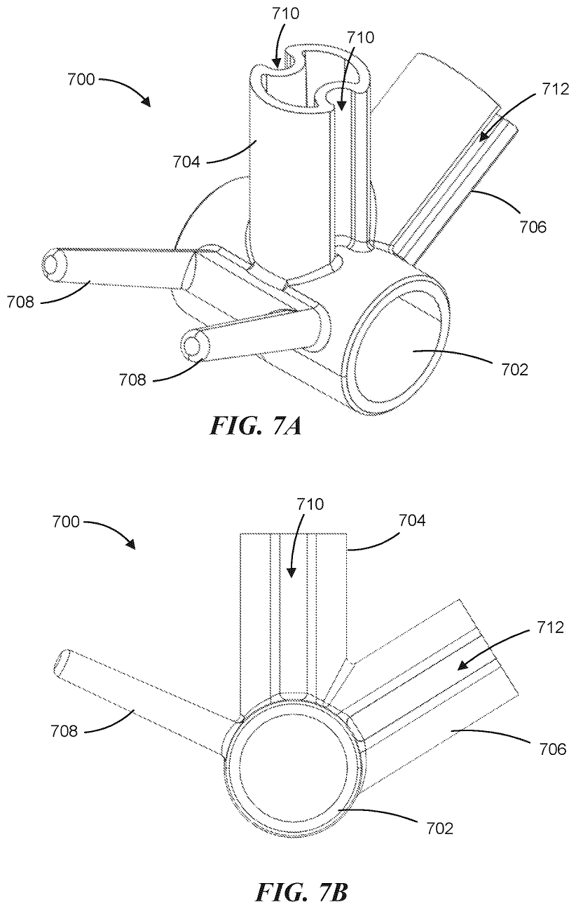

FIGS. 7A and 7B illustrate a bottom bracket fitting or knuckle 700 configured in accordance with embodiments of the disclosed technology. The bottom bracket knuckle 700 can include a cylindrical crank bearing housing 702, a seat tube lug 704 extending from the crank bearing housing 702 and configured to extend into an end portion of a bicycle frame seat tube (not shown), and a down tube lug 706 extending from the crank bearing housing 702 and configured to extend into an end portion of a bicycle frame down tube (not shown). As shown in FIG. 7A, the bottom bracket knuckle 700 can also include a pair of chain stay lugs 708 extending from the crank bearing housing 702 and into a corresponding one of a pair of chain stay tubes (not shown). In some embodiments, the seat tube lug 704 and the down tube lug 706 can each include a pair of channels 710 and 712, respectively, that extend along at least a portion of the length of the lugs. As explained above, the channels 710 and 712 provide clearance for cable housings and/or wires. The channels can be positioned on opposite sides of the lugs (as shown) and/or on the top and bottom sides of the lugs. The channels 710/712 are an optional feature that may not be included in some embodiments of the bottom bracket knuckle 700.

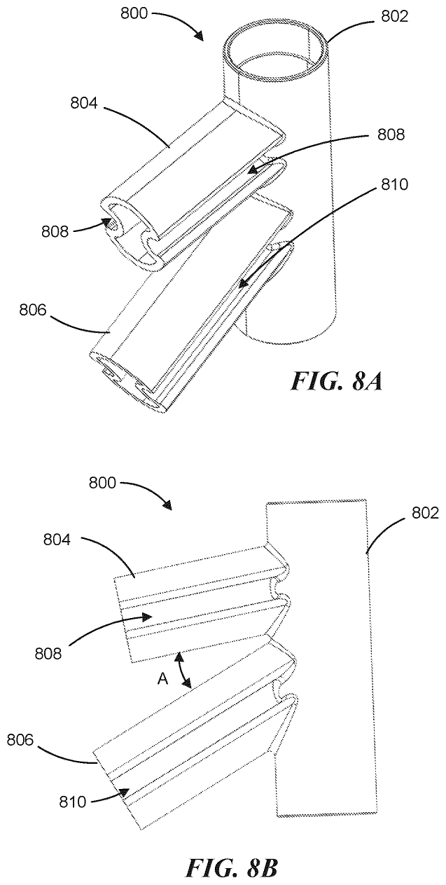

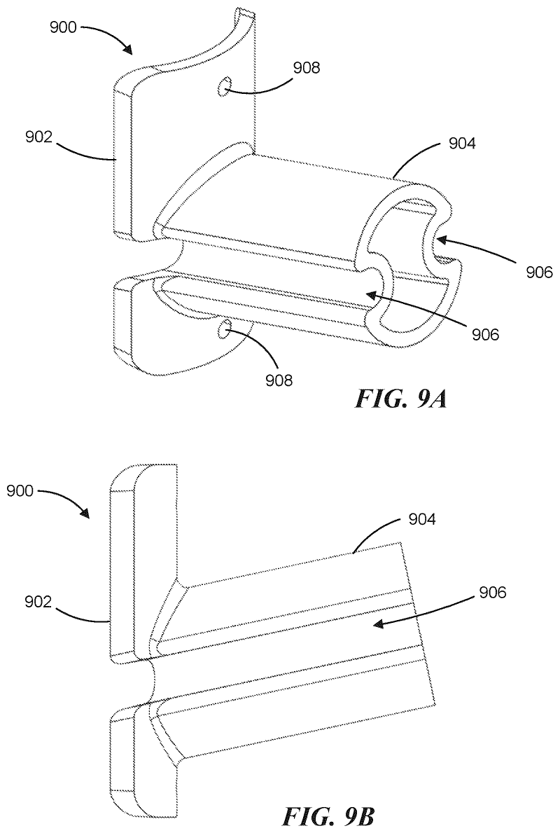

FIGS. 8A and 8B illustrate an inclined head tube fitting or knuckle 800 configured in accordance with additional embodiments of the disclosed technology. The inclined head tube knuckle 800 is similar to the head tube knuckle 400; however (as best seen in FIG. 8B), the top tube lug 804 is angled downward. In other words, the angle A (FIG. 8B) between the top tube lug 804 and the down tube lug 806 is smaller than that of a similar angle from head tube knuckle 400 (FIGS. 4A and 4B). The inclined head tube knuckle 800 can be used with an inclined head tube adapter 900 (FIGS. 9A and 9B) to produce an inclined top tube style bicycle frame. The inclined head tube knuckle 800 can include a cylindrical fork tube housing 802. The top tube lug 804 extends from the housing 802 and is configured to extend into an end portion of a bicycle frame top tube (not shown). The down tube lug 806 extends from the housing 802 and is configured to extend into an end portion of a bicycle frame down tube (not shown). In some embodiments, the top tube lug 804 and the down tube lug 806 can each include a pair of channels 808 and 810, respectively, that extend along at least a portion of the length of the lugs. The channels can be positioned on opposite sides of the lugs (as shown) and/or on the top and bottom of the lugs. As with the other channels described previously, channels 808/810 are an optional feature that may not be included in some embodiments of the head tube knuckle 800.

FIGS. 9A and 9B illustrate an inclined head tube adapter 900 configured in accordance with embodiments of the disclosed technology. Referring to FIG. 6B and FIGS. 9A and 9B together, the head tube adapter 900 can be positioned on the seat post housing 602 below the top tube lug 604. Optionally, the top tube lug 604 can be removed from the seat tube knuckle 600. The head tube adapter 900 can include a contoured mounting plate 902 and a top tube lug 904 extending at an angle from the mounting plate 902 (as best seen in FIG. 9B). The top tube lug 904 is angled such that a top tube mated to the top tube lug 904 will align with the top tube lug 804 of the inclined head tube knuckle 800 of FIGS. 8A and 8B. The mounting plate 902 can include one or more apertures 908 (two are shown in the illustrated embodiment) to facilitate fastening of the inclined head tube adapter 900 to the seat tube housing 602 (FIG. 6B) with suitable fasteners, e.g., rivets, screws). In some embodiments, the top tube lug 904 can also include a pair of channels 906 that extend along at least a portion of the length of the lug. The channels 906 can be positioned on opposite sides of the lug 904 (as shown) and/or on the top and bottom of the lug 904. The channels 906 are an optional feature that may not be included in some embodiments of the head tube adapter 900.

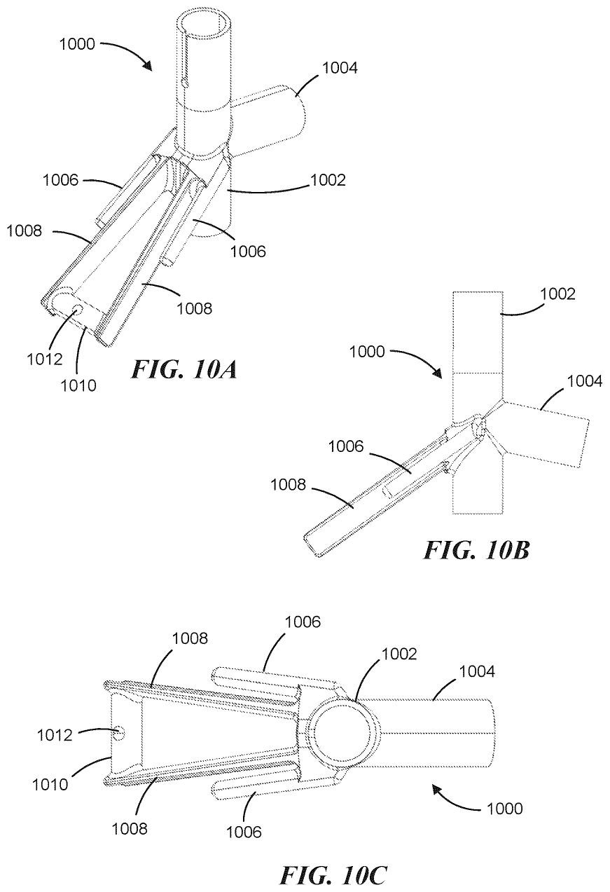

FIGS. 10A, 10B, and 10C illustrate a seat tube fitting or knuckle 1000 configured in accordance with additional embodiments of the disclosed technology. For example, the seat tube knuckle 1000 can include a cylindrical seat post housing 1002 configured to extend into an end portion of a bicycle frame seat tube. The seat tube knuckle 1000 can also include a top tube lug 1004 extending from the seat post housing 1002 and configured to extend into an end portion of a bicycle frame top tube. A pair of seat stay lugs 1006 each extend from the seat post housing 1002 and are configured to extend into a corresponding one of a pair of bicycle frame seat stay tubes. The seat tube knuckle 1000 differs from the seat tube knuckle 600 (FIGS. 6A and 6B) in that the seat tube knuckle 1000 includes a pair of contoured reinforcement members 1008 positioned between the pair of seat stay lugs 1006. Each contoured reinforcement member 1008 can be configured to engage an outer surface of a corresponding one of a pair of seat stay tubes (not shown). A cross member 1010 extends between distal ends of the contoured reinforcement members 1008. The cross member 1010 provides additional support for the seat stay tubes and is sized and shaped to provide a mounting location for caliper type bicycle brakes, which can be secured to the cross member 1010 with a suitable fastener (not shown) extending through aperture 1012.

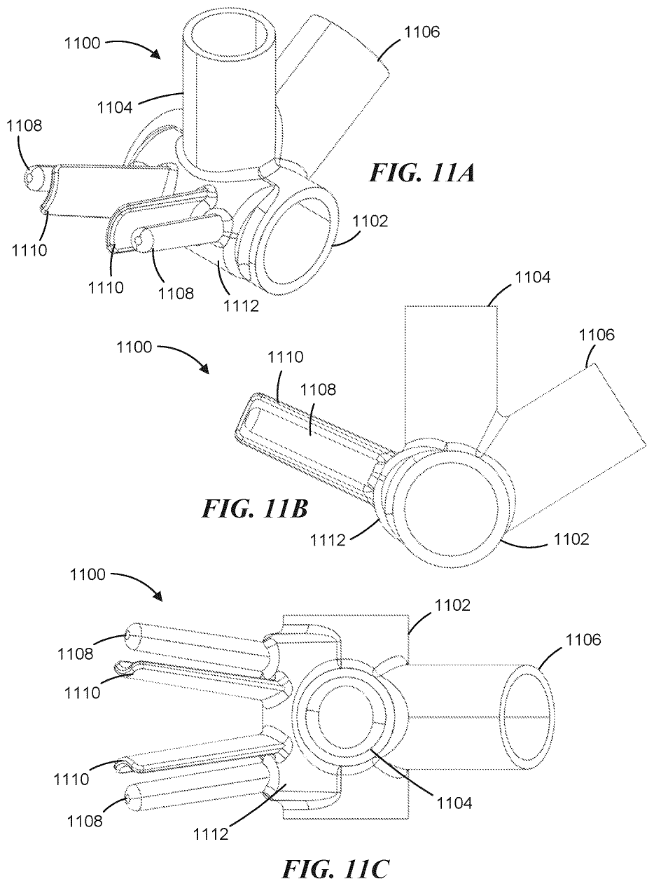

FIGS. 11A, 11B, and 11C illustrate a bottom bracket fitting or knuckle 1100 configured in accordance with additional embodiments of the disclosed technology. The bottom bracket knuckle 1100 can include a cylindrical crank bearing housing 1102, a seat tube lug 1104 extending from the crank bearing housing 1102 and configured to extend into an end portion of a bicycle frame seat tube, a down tube lug 1106 extending from the crank bearing housing 1102 and configured to extend into an end portion of a bicycle frame down tube. The bottom bracket knuckle 1100 can also include a pair of chain stay lugs 1108 extending from the crank bearing housing 1102 and into a corresponding one of a pair of chain stay tubes. The bottom bracket knuckle 1100 can also include a pair of contoured reinforcement members 1110 positioned between the pair of chain stay lugs 1108. Each contoured reinforcement member is configured to confront an outer surface of a corresponding one of a pair of chain stay tubes positioned on the chain stay lugs 1108. In some embodiments, the bottom bracket knuckle 1100 also includes a reinforcement boss 1112 from which the chain stay lugs 1108 extend.

### EXAMPLES

Several aspects of the present technology are set forth in the following examples:

1. A bicycle frame, comprising:
a top tube, a down tube, a seat tube, a pair of chain stays, a pair of seat stays, and a pair of dropouts connecting the pair of chain stays with the pair of seat stays;
a head tube knuckle, including:
   a cylindrical fork tube housing;
   a top tube lug extending from the fork tube housing and into a first end portion of the top tube; and
   a down tube lug extending from the fork tube housing and into a first end portion of the down tube;
a bottom bracket knuckle, including:
   a cylindrical crank bearing housing;
   a seat tube lug extending from the crank bearing housing and into a first end portion of the seat tube;
   a down tube lug extending from the crank bearing housing and into a second end portion of the down tube; and
   a pair of chain stay lugs each extending from the crank bearing housing and into a corresponding one of the pair of chain stay tubes; and
a seat tube knuckle, including:
   a cylindrical seat post housing extending into a second end portion of the seat tube;
   a top tube lug extending from the seat post housing and into a second end portion of the top tube; and
   a pair of seat stay lugs each extending from the seat post housing and into a corresponding one of the pair of seat stay tubes.

2. The bicycle frame of example 1 wherein at least one of the top tube, the down tube, the seat tube, the pair of chain stays, and the pair of seat stays is composed of bamboo.

3. The bicycle frame of example 1 or 2 wherein:
the head tube knuckle includes at least one channel extending along a length of at least one of the top tube lug and the bottom tube lug,
the bottom bracket knuckle includes at least one channel extending along a length of at least one of the down tube lug and the seat tube lug, and
the seat tube knuckle includes at least one channel extending along a length of the top tube lug.

4. The bicycle frame of any one of examples 1 to 3, further comprising a cable housing extending at last partially through the down tube and along a channel extending along a length of the down tube lug.

5. The bicycle frame of any one of examples 1 to 4, further comprising a wire extending through the top tube and at least partially along a channel extending along a length of the top tube lug.

6. The bicycle frame of any one of examples 1 to 5 wherein:
the bottom bracket knuckle further comprises a pair of contoured reinforcement members positioned between the pair of chain stay lugs, wherein each reinforcement member and each engage an outer surface of a corresponding one of the pair of chain stay tubes, and
the seat tube knuckle further comprises a pair of contoured reinforcement members positioned between the pair of seat stay lugs and each engaging an outer surface of a corresponding one of the pair of seat stay tubes.

7. The bicycle frame of any one of examples 1 to 6 wherein the seat tube knuckle further comprises a brake mount extending between the pair of contoured reinforcement members.

8. The bicycle frame of any one of examples 1 to 7 wherein the top tube, the down tube, the seat tube, the pair of chain stays, the pair of seat stays, the head tube knuckle, the bottom bracket knuckle, and the seat tube knuckle are further secured together with epoxy.

9. A bicycle frame knuckle, comprising:
a cylindrical housing;
a first tube lug extending from the housing and configured to extend into a first end portion of a first bicycle frame tube; and
a second tube lug extending from the housing and configured to extend into an end portion of a second bicycle frame tube,
wherein at least one of the first tube lug and the second tube lug includes at least one channel formed therein and extending at least partially along its length.

10. The bicycle frame knuckle of example 9 wherein:
the housing is a fork tube housing,
the first tube lug is a top tube lug, and
the second tube lug is a down tube lug.

11. The bicycle frame knuckle of example 9 or 10 wherein:
the housing is a crank bearing housing,
the first tube lug is a down tube lug, and
the second tube lug is a seat tube lug.

12. The bicycle frame knuckle of any one of examples 9 to 11, further comprising a pair of chain stay lugs extending from the crank bearing housing.

13. The bicycle frame knuckle of any one of examples 9 to 12 wherein:
the housing is a seat post housing,
the first tube lug is a top tube lug, and
the second tube lug is a seat tube lug.

14. The bicycle frame knuckle of any one of examples 9 to 13, further comprising a pair of seat stay lugs extending from the seat post housing.

15. A bicycle frame fitting, comprising:
a cylindrical housing;
a first tube lug extending from the housing and configured to extend into a first end portion of a first bicycle frame tube;
a pair of second tube lugs each extending from the housing and configured to extend into an end portion of a corresponding one of a pair of second bicycle frame tubes; and
a pair of contoured reinforcement members positioned between the pair of second tube lugs and positioned to engage an outer surface of a corresponding one of the pair of second bicycle frame tubes.

16. The bicycle frame fitting of example 15 wherein:
the housing is a crank bearing housing,
the first tube lug is a down tube lug, and
the pair of second tube lugs are chain stay lugs.

17. The bicycle frame fitting of example 15 or 16, further comprising a seat tube lug extending from the crank bearing housing.

18. The bicycle frame fitting of any one of examples 15 to 17 wherein:
the housing is a seat post housing,
the first tube lug is a top tube lug, and
the pair of second tube lugs are seat stay lugs.

19. The bicycle frame fitting of any one of examples 15 to 18, further comprising a brake mount extending between the pair of contoured reinforcement members.

20. The bicycle frame fitting of any one of examples 15 to 19 wherein the frame fitting is composed of metal.

### Conclusion

The above detailed description of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, any of the features of the bicycle frame knuckles described herein may be combined with any of the features of the other knuckles described herein and vice versa. Also, different knuckle configurations can be included in a single frame. For example, the head tube knuckle 400 of FIGS. 4A and 4B can be combined with the bottom bracket knuckle 1100 of FIGS. 11A-11C. Furthermore, the channels 710 and 712 shown and described in FIGS. 7A and 7B may be used with knuckle 1100 of FIGS. 11A-11C, for example. Moreover, although the assembly steps are presented in a given order, alternative embodiments may perform steps in a different order. The various embodiments described herein may also be combined to provide further embodiments. Although the technology is shown and described herein with reference to bamboo frame tubes, the disclosed technology can be applied other suitable frame member materials, such as plastic tubes, metal tubes, carbon fiber tubes, composite tubes, timber members (e.g., hardwood and softwood), plywood members, and oriented strand board (OSB) members, to name a few.

The disclosed knuckles provide advantages over conventional techniques in that they allow a bicycle frame to be quickly assembled manually with few or no tools. In addition, the lugs of each knuckle help ensure alignment of the frame tubes and repeatability of the frame joints. Furthermore, the knuckles can be preformed (e.g., cast, molded, or machined) which provides for efficient and cost-effective frame fabrication.

From the foregoing, it will be appreciated that specific embodiments of the technology have been described herein for purposes of illustration, but well-known structures and functions associated with bicycles, bicycle frames, and components have not been shown or described in detail to avoid unnecessarily obscuring the description of the embodiments of the technology. For example, the frame tube diameters, lengths, and frame geometries (e.g., angles) are well known in the art and can vary depending on the application and frame size as necessary. Where the context permits, singular or plural terms may also include the plural or singular term, respectively.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A bicycle frame, comprising:
a top tube, a down tube, a seat tube, a pair of chain stays, a pair of seat stays, and a pair of dropouts connecting the pair of chain stays with the pair of seat stays;
a head tube knuckle, including:
a cylindrical fork tube housing;
a top tube lug extending from the fork tube housing and into a first end portion of the top tube; and
a down tube lug extending from the fork tube housing and into a first end portion of the down tube;
a bottom bracket knuckle, including:
a cylindrical crank bearing housing;
a seat tube lug extending from the crank bearing housing and into a first end portion of the seat tube;
a down tube lug extending from the crank bearing housing and into a second end portion of the down tube; and
a pair of chain stay lugs each extending from the crank bearing housing and into a corresponding one of the pair of chain stay tubes; and
a seat tube knuckle, including:
a cylindrical seat post housing extending into a second end portion of the seat tube;
a top tube lug extending from the seat post housing and into a second end portion of the top tube; and
a pair of seat stay lugs each extending from the seat post housing and into a corresponding one of the pair of seat stay tubes.

2. The bicycle frame of claim 1 wherein at least one of the top tube, the down tube, the seat tube, the pair of chain stays, and the pair of seat stays is composed of bamboo.

3. The bicycle frame of claim 1 wherein:
the head tube knuckle includes at least one channel extending along a length of at least one of the top tube lug and the bottom tube lug,
the bottom bracket knuckle includes at least one channel extending along a length of at least one of the down tube lug and the seat tube lug, and
the seat tube knuckle includes at least one channel extending along a length of the top tube lug.

4. The bicycle frame of claim 3, further comprising a cable housing extending at least partially through the down tube and along a channel extending along a length of the down tube lug.

5. The bicycle frame of claim 3, further comprising a wire extending through the top tube and at least partially along a channel extending along a length of the top tube lug.

6. The bicycle frame of claim 1 wherein:
the bottom bracket knuckle further comprises a pair of contoured reinforcement members positioned between the pair of chain stay lugs, wherein each reinforcement member engages an outer surface of a corresponding one of the pair of chain stay tubes, and
the seat tube knuckle further comprises a pair of contoured reinforcement members positioned between the pair of seat stay lugs and each engaging an outer surface of a corresponding one of the pair of seat stay tubes.

7. The bicycle frame of claim 6 wherein the seat tube knuckle further comprises a brake mount extending between the pair of contoured reinforcement members.

8. The bicycle frame of claim 7, wherein the top tube, the down tube, the seat tube, the pair of chain stays, the pair of seat stays, the head tube knuckle, the bottom bracket knuckle, and the seat tube knuckle are further secured together with epoxy.

9. A bicycle frame knuckle, comprising:
a cylindrical housing;
a first tube lug extending from the housing and configured to extend into a first end portion of a first bicycle frame tube; and
a second tube lug extending from the housing and configured to extend into an end portion of a second bicycle frame tube,
wherein at least one of the first tube lug and the second tube lug includes at least one channel formed therein and extending at least partially along its length.

10. The bicycle frame knuckle of claim 9 wherein:
the housing is a fork tube housing,
the first tube lug is a top tube lug, and
the second tube lug is a down tube lug.

11. The bicycle frame knuckle of claim 9 wherein:
the housing is a crank bearing housing,
the first tube lug is a down tube lug, and
the second tube lug is a seat tube lug.

12. The bicycle frame knuckle of claim 11, further comprising a pair of chain stay lugs extending from the crank bearing housing.

13. The bicycle frame knuckle of claim 9 wherein:
the housing is a seat post housing,
the first tube lug is a top tube lug, and
the second tube lug is a seat tube lug.

14. The bicycle frame knuckle of claim 13, further comprising a pair of seat stay lugs extending from the seat post housing.

15. A bicycle frame fitting, comprising:
a cylindrical housing;
a first tube lug extending from the housing and configured to extend into a first end portion of a first bicycle frame tube;
a pair of second tube lugs each extending from the housing and configured to extend into an end portion of a corresponding one of a pair of second bicycle frame tubes; and
a pair of contoured reinforcement members positioned between the pair of second tube lugs and positioned to engage an outer surface of a corresponding one of the pair of second bicycle frame tubes.

16. The bicycle frame fitting of claim 15 wherein:
the housing is a crank bearing housing,
the first tube lug is a down tube lug, and
the pair of second tube lugs are chain stay lugs.

17. The bicycle frame fitting of claim 16, further comprising a seat tube lug extending from the crank bearing housing.

18. The bicycle frame fitting of claim 15 wherein:
the housing is a seat post housing,
the first tube lug is a top tube lug, and
the pair of second tube lugs are seat stay lugs.

19. The bicycle frame fitting of claim 18, further comprising a brake mount extending between the pair of contoured reinforcement members.

20. The bicycle frame fitting of claim 15 wherein the frame fitting is composed of metal.
